(19) United States
(12) Patent Application Publication
(10) Pub. No.: US 2026/0008107 A1
(43) Pub. Date: Jan. 8, 2026

(54) HORIZONTAL MACHINING LATHE WITH SHOCK-ABSORBING BRAKING MECHANISM

(71) Applicant: Zhilin YANG, Huangshan City (CN)

(72) Inventor: Zhilin YANG, Huangshan City (CN)

(21) Appl. No.: 18/761,694

(22) Filed: Jul. 2, 2024

(51) Int. Cl. B23B 13/02

(52) U.S. Cl. CPC B23B 13/02

(57) ABSTRACT

A horizontal machining lathe with a shock-absorbing braking mechanism includes a lathe body including a lathe bed, a chuck, a spindle box, and a slide box. The chuck is arranged on an output end of the spindle box. The lathe bed is provided with the spindle box at one end of and a tailstock base at the other end. The lathe bed is provided with a guide rail, and the slide box is provided with a tool holder assembly. An end of the inner shaft proximate to the chuck is provided with a brake disc, and the spindle box is provided with a spindle braking device including first and second brake devices symmetrically arranged on both sides of the brake disc and a reset device arranged therebetween.

### FIELD OF THE INVENTION

The disclosure relates to a machining equipment, in particular to a horizontal machining lathe with a shock-absorbing braking mechanism.

### BACKGROUND

CNC machine tools can automatically process the parts to be machined according to the pre-programmed processing program. A machining process is given in the specified instruction code and program format, depending on the CNC machine tools, which details the processing route, process parameters, tool motion trajectory, displacement amounts, cutting parameters, and auxiliary functions required for the part. Next, the machining process is stored in a control medium, which can be applied into the numerical control device, so as to direct the machine tool to process the part. A CNC lathe is one of the most widely used CNC machine tools at present. The CNC lathe primarily works for cutting machining of internal and external cylindrical surfaces of shaft parts or disc parts, internal and external conical surfaces of arbitrary cone angles, complex rotational internal and external curved surfaces, cylindrical and conical threads, etc. It is also capable of performing other operations such as slotting, drilling, reaming, tapping, and boring, among others.

CN patent application No. 200420096470.4 discloses a medium-sized horizontal lathe, wherein the motor is connected to the spindle box of the lathe through a belt pulley, and the power is transmitted from the first shaft to the second, then to the fourth, and finally to the main shaft. However, due to the involvement of multiple transmission structures, there may be energy loss during power transmission between them. Furthermore, the brake of the main shaft relies on motor braking, which will result in vibration and thereby affect the cutting performance, as kinetic energy is transferred to the main shaft during the deceleration process.

### SUMMARY

Aiming at the technical defects existing in the prior art, a horizontal machining lathe with a shock-absorbing braking mechanism is provided to solve the above technical problems and meet the actual demands.

The horizontal machining lathe with a shock-absorbing braking mechanism comprises a lathe body including a lathe bed, a chuck, a spindle box, and a slide box. The chuck is arranged on an output end of the spindle box. One end of the lathe bed is provided with the spindle box, with the other end provided with a tailstock base. The lathe bed is provided with a guide rail, and the slide box is provided with a tool holder assembly. The spindle box is provided with a spindle assembly and a power device is connected to the spindle assembly. The spindle assembly includes an inner shaft and an outer shaft, wherein an outer surface of the inner shaft is provided with a spring set, both ends of the spring set are respectively connected to the inner shaft and the outer shaft, the inner shaft passes through the middle of the outer shaft, and the spring set wraps around the inner shaft.

An end of the inner shaft proximate to the chuck is provided with a brake disc, and the spindle box is provided with a spindle braking device connected to the spindle assembly. The spindle braking device includes a first brake device and a second brake device symmetrically arranged on both sides of the brake disc, as well as a reset device arranged between the first brake device and the second brake device. The first brake device and the second brake device are respectively driven by means of oil pipes on the outer surface of the spindle box, and the first brake device and the second brake device are respectively provided with brake pads towards the brake disc.

According to an embodiment, the first brake device includes a first cylinder with an opening facing the brake disc, a first piston arranged in the first cylinder, a first piston rod arranged at the rear end of the first piston, and a first slider arranged at the front end of the first piston, wherein an end of the first slider facing the brake disc is provided with a first brake pad.

Furthermore, the first cylinder is provided with a first oil passage, and the outer surface of the spindle box is provided with a first oil pipe connected to one end of the first oil passage, with the other end of the first oil passage connected to the rear end of the piston rod. One end of the first piston rod facing the first oil passage is provided with a first scaling block.

In addition, the second brake device includes a second cylinder with an opening facing the brake disc, a second piston arranged in the second cylinder, a second piston rod arranged at the rear end of the second piston, and a second slider arranged at the front end of the second piston, wherein an end of the second slider facing the brake disc is provided with a second brake pad.

Furthermore, the second cylinder block is provided with a second oil passage, and the outer surface of the spindle box is provided with a second oil pipe connected to one end of the second oil passage, with the other end of the second oil passage connected to the rear end of the piston rod, and one end of the second piston rod facing the second oil passage is provided with a first sealing block.

According to an embodiment, the reset device includes a chamber with an opening facing the brake disc, a third piston arranged in the chamber, a third slider arranged at the front end of the third piston, and a third piston rod arranged at the rear end of the third piston, wherein the rear end of the third piston rod extends out of the spindle box, and the end of the third piston facing the chamber is provided with an actuator spring.

According to another embodiment, the power device includes a power shaft, a first gear set and a second gear set surrounding the power shaft, wherein the transmission between the power shaft and the outer shaft is accomplished by the engagement between the first gear set and the second gear set.

According to another embodiment, the spring set includes a first spring and a second spring, wherein the first spring and the second spring are arranged alternately. One end of the first spring is connected to the inner shaft, and the other end is connected to the outer shaft. One end of the second spring is connected to the inner shaft, and the other end is connected to the outer shaft.

Furthermore, a spring space is formed between the outer shaft and the inner shaft, and the width of the spring space is larger than the width of the spring set. One end of the spring set connected to the inner shaft is horizontally fitted to the inner shaft, and one end of the spring set connected to the outer shaft is bent, away from the inner shaft, and connected to the outer shaft toward the side.

The beneficial effects of the present disclosure lie in:
The brake disc is provided at a position proximate to the chuck on the inner shaft, and a first brake device and a second brake device are symmetrically provided in the spindle box corresponding to the position of the brake disc. The first brake device and the second brake device push the first brake pad and the second brake pad on both sides of the brake disc through hydraulic oil to perform braking operation, and the reset device can reset the first brake pad and the second brake pad after the hydraulic oil pressure lowers or disappears. In this manner, the overall braking system of the present disclosure has advantages of a simple structure, convenience and reliability, and a fast braking speed.

The inner shaft and the outer shaft are connected by the spring set. When the torque is forwardly or clockwise transmitted, the first spring and the second spring are twisted and then wound on the inner shaft, so as to drive the outer shaft to rotate. When the torque is reversely transmitted, the first spring and the second spring are twisted and then wound on the outer shaft, so as to drive the outer shaft to rotate. There is a certain gap between the spring set and the inner shaft and between the spring set and the outer shaft to reserve a deformation margin to form a buffer and reduce vibration.

### BRIEF DESCRIPTION OF THE DRAWINGS

FIG. 1 is a schematic diagram of the overall structure of the horizontal machining lathe with a shock-absorbing braking mechanism in the present disclosure.

FIG. 2 is a structural schematic diagram of the spindle box of the disclosure.

FIG. 3 is a first enlarged schematic diagram of the structure of part A in FIG. 2.

FIG. 4 is a second enlarged schematic diagram of the structure of part A in FIG. 2.

FIG. 5 is a schematic diagram of the structure of the spring set of the present disclosure.

FIG. 6 is a schematic diagram of the structure of the latching end of the disclosure.

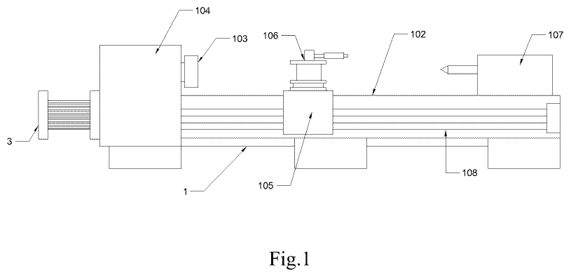

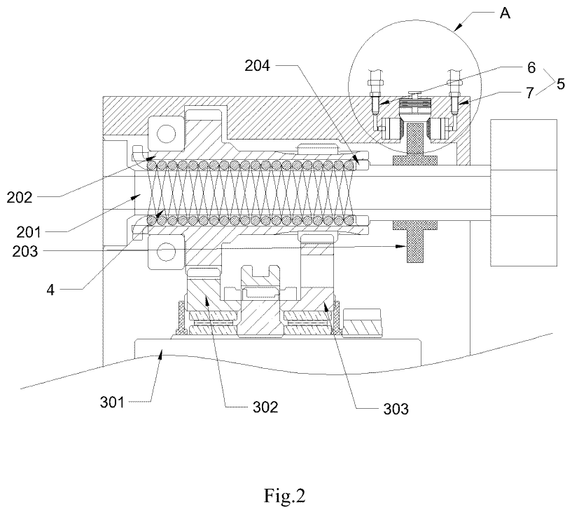

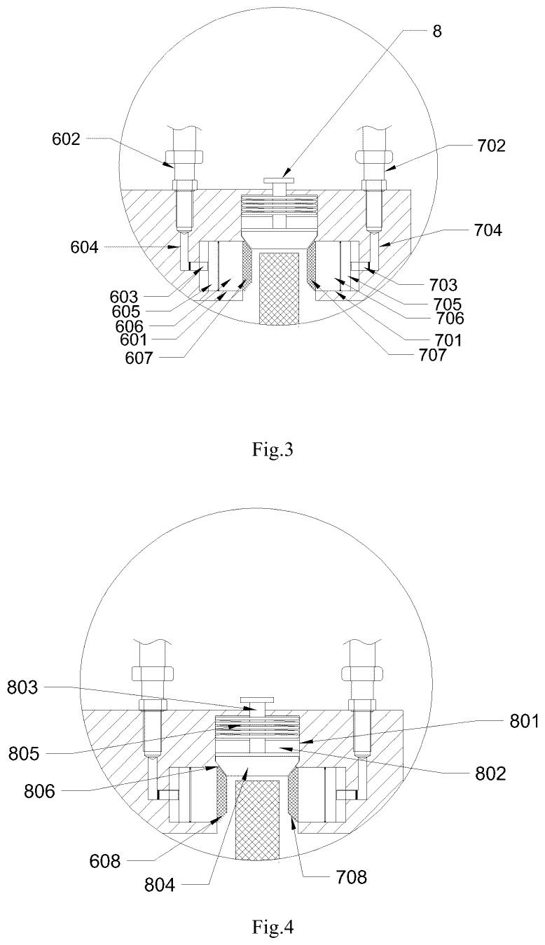

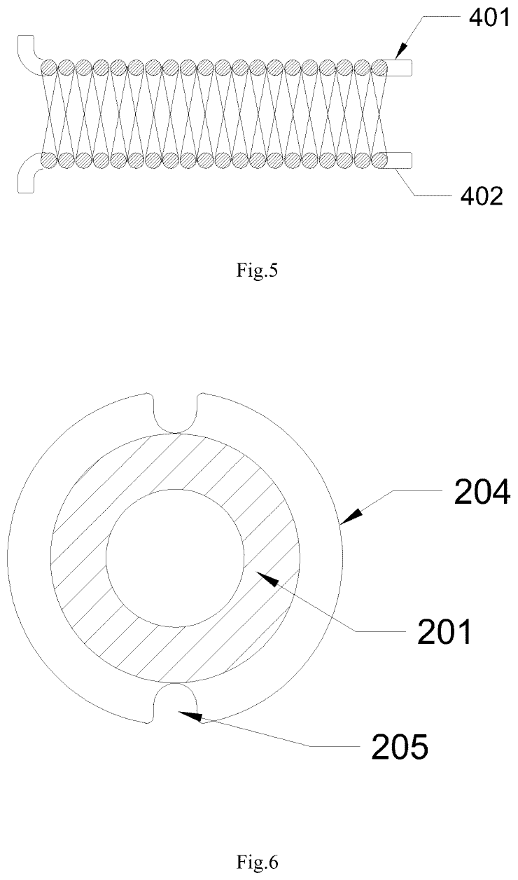

### DETAILED DESCRIPTION

Embodiments of the present disclosure are described below in conjunction with the accompanying drawings and related examples, but not limited to the following examples. The necessary components related to this technical field in the present disclosure should be regarded as common sense in the art, which can be understood by those skilled in the art.

A horizontal machining lathe with a shock-absorbing braking mechanism includes a lathe body 1 including a lathe bed 102, a chuck 103, a spindle box 104, and a slide box 105. The chuck 103 is arranged on an output end of the spindle box 104. One end of the lathe bed 102 is provided with the spindle box 104, with the other end provided with a tailstock base 107. The lathe bed 102 is provided with a guide rail 108, and the slide box 105 is provided with a tool holder assembly 106.

The spindle box 104 is provided with a spindle assembly 2 therein and a power device 3 is connected to the spindle assembly 2. The spindle assembly 2 includes an inner shaft 201 and an outer shaft 202 with a bore, wherein an outer surface of the inner shaft 201 is provided with a spring set 4, both ends of the spring set 4 are respectively connected to the inner shaft 201 and the outer shaft 202, the inner shaft 201 is arranged in the bore of the outer shaft 202, and the spring set 4 wraps around the inner shaft 201.

An end of the inner shaft 201 proximate to the chuck 103 is provided with a brake disc 203, and the spindle box 104 is provided with a spindle braking device 5 for the spindle assembly 2. The spindle braking device 5 includes a first brake device 6 and a second brake device 7 symmetrically arranged on both sides of the brake disc 203, as well as a reset device 8 arranged between the first brake device 6 and the second brake device 7. The first brake device 6 and the second brake device 7 are respectively driven by means of oil pipes arranged on the outer surface of the spindle box 104, and the first brake device 6 and the second brake device 7 are respectively provided with a brake pad facing towards the brake disc 203.

In terms of the structure, the end of the inner shaft 201 proximate to the chuck 103 is provided with the brake disc 203, wherein the brake disc 203 has a circular cross-section and rotates synchronously with the inner shaft 201. The two sides of the brake disc 203 are respectively provided with the first brake device 6 and the second brake device 7, wherein the first braking device 6 and the second braking device 7 are driven by hydraulic oil for braking, and the first brake device 6 and the second brake device 7 are respectively provided with a first oil pipe 602 and a second oil pipe 702 extending out of the outer surface of the spindle box 104, thereby being driven by means of a device for delivering hydraulic oil.

According to an embodiment, the first brake device 6 includes a first cylinder 601 with an opening facing the brake disc 203, a first piston 605 arranged in the first cylinder 601, a first piston rod 603 arranged at the rear end of/fixed to the first piston 605, and a first slider 606 arranged at the front end of/fixed to the first piston 605, wherein an end surface of the first slider 606 facing the brake disc 203 is provided with a first brake pad 607. In the operation, the first piston 605 is in close contact with an inner wall of the first cylinder 601, and the first piston 605 is driven by the first piston rod 603 at its rear end to push the first slider 606 towards the opening of the first cylinder 601, such that the first brake pad 607 on the first slider 606 is pushed towards the brake disc 203 until it contacts with the brake disc 203 to perform frictional deceleration.

Furthermore, the first cylinder 601 is provided with a first oil passage 604, and the outer surface of the spindle box 104 is provided with a first oil pipe 602 connected to one end of the first oil passage 604, with the other end of the first oil passage 604 connected to the rear end of the piston rod 603. The first piston rod 603 is provided with a first sealing block facing the first oil passage 604. When the hydraulic oil from the first oil pipe 602 is pumped into the first oil passage 604 and reaches the first sealing block, the first sealing block is pushed towards one end of the first piston rod 603, and then the first piston rod 603 pushes the first piston 605 towards the brake disc 203, so that the first slider 606 is pushed by the first piston 605 to move synchronously toward the brake disc 203.

In addition, the second brake device 7 includes a second cylinder 701 with an opening facing the brake disc 203, a second piston 705 arranged in the second cylinder 701, a second piston rod 703 arranged at the rear end of the second piston 705, and a second slider 706 arranged at the front end of the second piston 705, wherein an end surface of the second slider 706 facing the brake disc 203 is provided with a second brake pad 707.

Furthermore, the second cylinder block 701 is provided with a second oil passage 704, and the outer surface of the spindle box 104 is provided with a second oil pipe 702 connected to one end of the second oil passage 704, with the other end of the second oil passage 704 connected to the rear end of the piston rod 703, and the second piston rod 703 is provided with a first sealing block facing the second oil passage 704.

It should be noted that the first brake device 6 and the second brake device 7 are arranged symmetrically along both sides of the brake disc 203, and the corresponding structures and components may be same. The first brake device 6 and the second brake device 7 are respectively provided with a first brake pad 607 and a second brake pad 707. The distance between the first brake pad 607 and the brake disc 203 is the same as the distance between the second brake pad 707 and the brake disc 203, such that the brake disc 203 can be clamped and restricted synchronously at both sides during braking operation, thereby achieving a better braking effect.

According to an embodiment, the reset device 8 includes a chamber 801 with an opening facing the brake disc 203, a third piston 802 arranged in the chamber 801, a third slider 804 arranged at the front end of the third piston 802, and a third piston rod 803 arranged at the rear end of the third piston 802, wherein the rear end of the third piston rod 803 extends out of the spindle box 104, and the end surface of the third piston 802 facing the chamber 801 is provided with an actuator spring 805.

It should be noted that, under the condition of the normal operation of the spindle box 104, there is no hydraulic oil pumped into the first brake device 6 and the second brake device 7, i.e., the oil pressure of the first oil passage 604 and the second oil passage 704 is zero, the reset device 8 separates the first brake pad 607 and the second brake pad 707 from the brake disc 203, so that the inner shaft 201 is capable of rotating normally or smoothly. Specifically, the third piston 802 pushes the third slider 804 towards the brake disc 203 by means of the actuator spring 805, and the end of the third sliding block 804 is stretched out to separate and reset the first brake pad 607 and the second brake pad 707 from the brake disc 203.

In the braking process of the spindle box 104, the hydraulic oil are respectively pumped through the first oil pipe 602 and the second oil pipe 702 and into the first oil passage 604 and the second oil passage 704. When the pressure in the first oil passage 604 and the second oil passage 704 exceeds a predetermined pressure—the elastic force of the actuator spring 805, the first piston rod 603 and the second piston rod 703 respectively push the first piston 605 and the second piston 705 to slide towards the brake disc 203, such that the front ends of the first slider 606 and the second slider 706 contact the brake disc 203 for braking. After stopping the brake operation, the oil pressure, in the first oil passage 604 and the second oil passage 704, returns to zero, and the third slider 804 pushes the first brake device 6 and the second brake device 7 to reset by means of the actuator spring 805. In this manner, the braking system of the present disclosure has advantages of a simple structure, convenience and reliability, and a fast braking speed.

According to an embodiment, the front end of the first brake pad 607 is provided with a first slope 608 facing the reset device 8, and the front end of the second brake pad 707 is provided with a second slope 708 facing the reset device 8. The width at the opening of the chamber 801 is smaller than the inner diameter of the active cavity 801. The front end of the third slider 804 is provided with third slopes 806 matching the opening of the chamber 801, at both sides. When resetting, the third slider 804 is forced to move downward under the action of the actuator spring 805, and the third slopes 806 are inserted downward between the first slope 608 and the second slope 708, such that the first braking device 6 and the second braking device 7 are reset. In this way, the structure is simpler and more reliable.

According to another embodiment, the power device 3 includes a power shaft 301, a first gear set 302 and a second gear set 303 surrounding the power shaft 301, wherein the transmission between the power shaft 301 and the outer shaft 202 is accomplished by the engagement between the first gear set 302 and the second gear set 303.

According to another embodiment, the spring set 4 includes a first spring 401 and a second spring 402, wherein the first spring 401 and the second spring 402 are arranged alternately. One end of the first spring 401 is connected to the inner shaft 201, and the other end is connected to the outer shaft 202, and one end of the second spring 402 is connected to the inner shaft 201, and the other end is connected to the outer shaft 202.

The inner shaft 201 and the outer shaft 202 are connected by the spring set 4. In one embodiment, when the torque is transmitted clockwise, the first spring 401 and the second spring 402 are twisted and then wound on the inner shaft 201, so as to drive the outer shaft 202 to rotate. When the torque is reversely transmitted, the first spring 401 and the second spring 402 are twisted and then wound on the outer shaft 202, so as to drive the outer shaft 202 to rotate. There is a certain gap between the spring set 4 and the inner shaft 201 and the outer shaft 202 to reserve a deformation margin to form a buffer and reduce vibration.

The inner shaft 201 is provided with a latching end 204 around the inner shaft 201 at an end proximate to the brake disc 203, wherein the latching end 204 is provided with U-shaped grooves 205 whose number corresponds to the number of springs in the spring set 4. The notch of the U-shaped groove 205 fits on the inner wall of the bore of the outer shaft 202, and one end of the spring set 4 connected to the inner shaft 201 is inserted into the U-shaped groove 205 of the latching end 204.

Furthermore, a spring space is formed between the outer shaft 202 and the inner shaft 201, and the width of the spring space is larger than the width of the spring set 4. The end of the spring set 4 connected to the inner shaft 201 is horizontally fitted on the inner shaft 201, and one end of the spring set 4 connected to the outer shaft 202 is bent (away from the inner shaft 201) and connected to the outer shaft 202. The winding angle of the spring group 4 around the inner shaft 201 or the outer shaft 202 ranges from 10° to 180°, which can be varied according to the actual cooperation between the inner shaft 201 and the outer shaft 202.

The above are only preferred embodiments of the present disclosure. It should be appreciated that, without departing from the principle of the present disclosure, some improvements and modifications can be made by those skilled in the art, and these improvements and modifications should also be regarded as falling into the scope of the present disclosure.

Reference lists: lathe main body 1, lathe bed 102, chuck 103, spindle box 104, slide box 105, tool holder assembly 106, tailstock base 107, guide rail 108, spindle assembly 2, inner shaft 201, outer shaft 202, brake disc 203, latching end 204, U-shaped groove 205, power device 3, power shaft 301, first gear set 302, second gear set 303, spring set 4, first spring 401, second spring 402, spindle braking device 5, first brake device 6, first cylinder 601, first oil pipe 602, first piston rod 603, first oil passage 604, first piston 605, first slider 606, first brake pad 607, first slope 608, second brake device 7, second cylinder 701, second oil pipe 702, second piston rod 703, second oil passage 704, second piston 705, second slider 706, second brake pad 707, second slope 708, reset device 8, chamber 801, third piston 802, third piston rod 803, third slide block 804, actuator spring 805, third slope 806.

What is claimed is:

1. A horizontal machining lathe with a shock-absorbing braking mechanism, comprising a lathe body, wherein the lathe body comprises a lathe bed, a chuck, a spindle box, and a slide box, and wherein the chuck is arranged on an output end of the spindle box, the lathe bed is provided with the spindle box at one end and a tailstock base at the other end, the lathe bed is provided with a guide rail, and the slide box is provided with a tool holder assembly;
wherein the spindle box is provided with a spindle assembly and a power device is connected to the spindle assembly, the spindle assembly includes an inner shaft and an outer shaft with a bore, and wherein the inner shaft is provided with a spring set on its outer surface, such that both ends of the spring set are respectively connected to the inner shaft and the outer shaft, wherein the inner shaft is arranged in the bore of the outer shaft, and the spring set wraps around the inner shaft; and
wherein an end of the inner shaft proximate to the chuck is provided with a brake disc, and wherein the spindle box is provided with a spindle braking device for the spindle assembly, the spindle braking device includes a first brake device and a second brake device symmetrically arranged on both sides of the brake disc, and a reset device arranged between the first brake device and the second brake device, the first brake device and the second brake device are respectively driven by means of oil pipes on the outer surface of the spindle box, and the first brake device and the second brake device are respectively provided with brake pads towards the brake disc.

2. The horizontal machining lathe with a shock-absorbing braking mechanism according to claim 1, wherein the first brake device includes a first cylinder with an opening facing the brake disc, a first piston arranged in the first cylinder, a first piston rod arranged at the rear end of the first piston, and a first slider arranged at the front end of the first piston, and wherein an end of the first slider facing the brake disc is provided with a first brake pad.

3. The horizontal machining lathe with a shock-absorbing braking mechanism according to claim 2, wherein the first cylinder is provided with a first oil passage, the spindle box is provided with a first oil pipe connected to the first oil passage, the first oil passage is connected to a rear end of the piston rod, and wherein an end of the first piston rod facing the first oil passage is provided with a first sealing block.

4. The horizontal machining lathe with a shock-absorbing braking mechanism according to claim 1, wherein the second brake device includes a second cylinder with an opening facing the brake disc, a second piston arranged in the second cylinder, a second piston rod arranged at the rear end of the second piston, and a second slider arranged at the front end of the second piston, and wherein an end of the second slider facing the brake disc is provided with a second brake pad.

5. The horizontal machining lathe with a shock-absorbing braking mechanism according to claim 4, wherein the second cylinder block is provided with a second oil passage, and the spindle box is provided with a second oil pipe connected to the second oil passage, the second oil passage is connected to the second piston rod, and an end of the second piston rod facing the second oil passage is provided with a first sealing block.

6. The horizontal machining lathe with a shock-absorbing braking mechanism according to claim 1, wherein the reset device includes a chamber with an opening facing the brake disc, a third piston arranged in the chamber, a third slider arranged at the front end of the third piston, and a third piston rod arranged at the rear end of the third piston, wherein the rear end of the third piston rod extends out of the spindle box, and an end of the third piston facing the chamber is provided with an actuator spring.

7. The horizontal machining lathe with a shock-absorbing braking mechanism according to claim 1, wherein the power device includes a power shaft, a first gear set and a second gear set surrounding the power shaft, and wherein the transmission between the power shaft and the outer shaft is accomplished by the engagement between the first gear set and the second gear set.

8. The horizontal machining lathe with a shock-absorbing braking mechanism according to claim 1, wherein the spring set includes a first spring and a second spring arranged alternately, wherein the first spring is connected to the inner shaft at one end and connected to the outer shaft at the other end, and the second spring is connected to the inner shaft at one end and connected to the outer shaft at the other end.

9. The horizontal machining lathe with a shock-absorbing braking mechanism according to claim 8, wherein a spring space is formed between the outer shaft and the inner shaft, and the width of the spring space is larger than the width of the spring set, and wherein an end of the spring set connected to the inner shaft is horizontally fitted to the inner shaft, and an end of the spring set connected to the outer shaft is bent, away from the inner shaft, and connected to the outer shaft.
